(19) United States
(12) Patent Application Publication
(10) Pub. No.: US 2024/0201057 A1
(43) Pub. Date: Jun. 20, 2024

(54) TOC ANALYZER

(71) Applicant: Endress+Hauser Conducta GmbH+Co. KG, Gerlingen (DE)

(72) Inventors: Christian Cramer, Stuttgart (DE); Eva-Maria Petat, Stuttgart (DE); Maik Röder, Benningen (DE); Joachim Rotter, Obersulm (DE); Kay Steen, Leinfelden-Echterdingen (DE)

(21) Appl. No.: 18/545,404

(22) Filed: Dec. 19, 2023

(30) Foreign Application Priority Data
Dec. 20, 2022 (DE) 10 2022 134 158.5

(51) Int. Cl. G01N 1/44; G01N 1/38; G01N 21/3504

(52) U.S. Cl. CPC G01N 1/44; G01N 1/38; G01N 21/3504

(57) ABSTRACT

The present disclosure discloses a TOC analyzer for determining a carbon content of a sample, comprising a reservoir vessel having a sample feed line and at least one sample removal line to a high-temperature furnace, a stirrer for stirring the sample in the reservoir vessel and at least one inlet for introducing CO₂-free gas into the sample in the reservoir vessel. The high-temperature furnace vaporizes and/or oxidizes the introduced sample at a high temperature so as to form water vapor and carbon dioxide gas. An analysis unit determines the carbon content of the sample on the basis of the carbon dioxide gas produced from the vaporization and/or oxidation of the sample. A data processing unit which is designed at least to control the inflow and outflow of the sample from and into the reservoir vessel or the high-temperature furnace, and to determine the carbon content of the sample.

### CROSS-REFERENCE TO RELATED APPLICATION

The present application is related to and claims the priority benefit of German Patent Application No. 10 2022 133 822.3, filed on Dec. 19, 2022, the entire contents of which are incorporated herein by reference.

### TECHNICAL FIELD

The present disclosure relates to a TOC analyzer for determining a carbon content of a sample.

### BACKGROUND

A TOC analyzer determines at least the TOC content, i.e., the “total organic carbon” content in a sample. TOC analyzers sometimes additionally determine the TIC, i.e., the “total inorganic carbon” content, or the TC, i.e., the “total carbon” content. The carbon content plays, for example, a major role in the analysis of water for contaminations, e.g., in wastewater, drinking water, sea water, and surface bodies of water, as well as in process water or in water for pharmaceutical applications.

In liquid samples, the carbon contained therein is typically converted to carbon dioxide either in a wet-chemical manner or using UV or combustion methods. The sample is combusted in a high-temperature furnace at 670-1200° C. In combustion methods (in particular at temperatures of <1000° C.), a catalyst is often used to ensure complete oxidation. In aqueous samples, therefore, in addition to carbon dioxide and other combustion gases, water vapor also arises, and is generally condensed after the combustion and separated from the carbon dioxide gas. Before the carbon dioxide gas is passed into the analysis unit, dusts, aerosols, and other gas constituents are sometimes removed from the carbon dioxide gas using filters and absorbers or adsorbers. A stream of a carrier gas transports the carbon dioxide gas to the analysis unit. Oxygen or mixtures of oxygen with nitrogen, for example, are used as carrier gas. The carbon content is often determined by means of a non-dispersive infrared (NDIR) sensor.

In the TOC measurement via the catalytic high-temperature method, an aliquot of the aqueous sample is metered into the hot reactor. The sample itself should be representative of the medium as a whole, and homogeneous. Because the total organic carbon (“TOC”) also contains particles in addition to the aqueous phase, the sample must be homogenized, i.e., comminuted and mixed, before the actual analysis. A relatively large volume is required for this purpose, from which only a precisely known, small representative volume is metered into the reactor. There, this is vaporized, and the organic ingredients of the sample oxidize to CO2. The CO2 is, as mentioned, conducted by carrier gas to the CO2 detector, and the CO2 concentration in the carrier gas is measured. The CO2 signal appears as a peak, ideally as a bell curve, and must be integrated over time. The “peak integral” is in turn proportional to the TOC concentration in the starting sample, after taking into account the sample volume used.

In order to ensure that only organic carbon is measured, the inorganic carbon compounds in the sample must first be removed. This is generally done by adding an acid to the sample. The inorganic carbon compounds are converted at a pH of <2 by the acid to form carbon dioxide. As CO2 is a gas dissolved in the liquid, it can be driven out of the sample using a CO2-free gas stream, which is blown through the sample as small bubbles while stirring. This process is generally referred to by the term “purge” or as “purging”.

This usually takes place via an injection needle or directly in a sample syringe, which is also referred to as a syringe plunger.

An injection needle is thus used to transport the desired sample volume into the furnace. The injection needle then also serves as a tool for purging the sample. The injection needle initially dips into the sample and the purge gas is blown through the needle and into the sample. Subsequently, the filled needle is moved into the injection head of the high-temperature furnace via a multi-axis robot in order to inject the sample. The movement of the entire syringe requires highly precise and thus very expensive automation using a plurality of linear drives.

Alternatively, the sample is prepared directly in a syringe plunger. After the sample itself and a certain amount of acid have been received in the syringe plunger, the syringe plunger is moved to the lowest point. Through a lateral bore located in the syringe body above the plunger, the purge gas is blown into the sample through a connected tube. In this system, the sample is accommodated in the syringe plunger. Since the samples are usually wastewater samples, they are normally not clean and also contain a proportion of particles. Upon receiving the sample, the plunger thus becomes contaminated. This results in problems being carried over from measurement to measurement. It is also not possible in this system to stir the sample, which would prevent the particles from settling in the syringe body. A custom product, of a precision syringe with a lateral bore for supplying the purge gas, is required for the purging process itself. The makes the system unnecessarily more expensive.

### SUMMARY

The object of the present disclosure is to remove inorganic compound from a sample.

The object is achieved by a TOC analyzer comprising a reservoir vessel having a sample feed line for the sample and at least one sample removal line to a high-temperature furnace, a stirrer for stirring the sample in the reservoir vessel, and at least one inlet for introducing CO2-free gas into the sample in the reservoir vessel; the high-temperature furnace for vaporizing and/or oxidizing the introduced sample at a high temperature so as to form water vapor and carbon dioxide gas; the analysis unit for determining the carbon content of the sample on the basis of the carbon dioxide gas formed during the evaporation and/or oxidation of the sample; and a data processing unit which is at least designed to control the inflow and outflow of the sample from and into the reservoir vessel or the high-temperature furnace, and to determine the carbon content of the sample.

The introduction of CO2-free gas serves to purge the sample in the reservoir vessel. The CO2-free gas is air, for example.

One embodiment provides for the stirrer to be configured as a magnetic stirrer.

One embodiment provides that the reservoir vessel comprises at least two, preferably four, sample removal lines, wherein the sample removal lines are arranged at different heights.

One embodiment provides that the inlet for introducing CO2-free gas into the reservoir vessel be designed as a capillary.

One embodiment provides that the reservoir vessel comprises at least two inlets for introducing CO2-free gas.

One embodiment provides that the inlet for introducing CO2-free gas be arranged close to the bottom.

One embodiment provides that the inlet for introducing CO2-free gas protrudes into the reservoir vessel such that the distance from all walls and other inlets is equal.

One embodiment provides that the reservoir vessel be designed as a hollow cylinder, in particular as a rotary part made of a plastics material. This then comprises, for example, standard bores, wherein connectors and an inlet (capillary) are catalog items.

One embodiment provides that the TOC analyzer comprises an inlet for a carrier gas, the inlet leading to a high-temperature furnace, wherein the carrier gas serves to transport the carbon dioxide gas formed during oxidation of the sample in the high-temperature furnace to the analysis unit.

One embodiment provides that the carrier gas consists of nitrogen, oxygen or a mixture of the two (“synthetic air”).

One embodiment provides that the analyzer comprises a filter between the high-temperature furnace and the analysis unit which is configured to filter acid gases, dust and/or aerosols.

The following advantages can then be achieved by means of the claimed TOC analyzer:

With respect to sample handling, water samples having a high particle content can be reproducibly measured by the available stirrer and the possibility of drawing off samples at different heights can be reproducibly measured.

This results in simple maintainability through the non-invasive shaft or storage for the stirrer, thus no wear or corrosion results. The purging capillary (input) does not tend to clog since the pressure due to the air flow rate blows particles free. The capillary can be easily replaced in the event of clogging.

In addition, good reproducibility results from the multiple measurements or from the possibility of mixed samples from different suction heights.

### BRIEF DESCRIPTION OF THE DRAWINGS

This is explained in more detail with reference to the following figures.

FIG. 1 shows a schematic embodiment of the claimed TOC analyzer.

FIG. 2 shows a reservoir vessel.

In the figures, the same features are labeled with the same reference signs.

### DETAILED DESCRIPTION

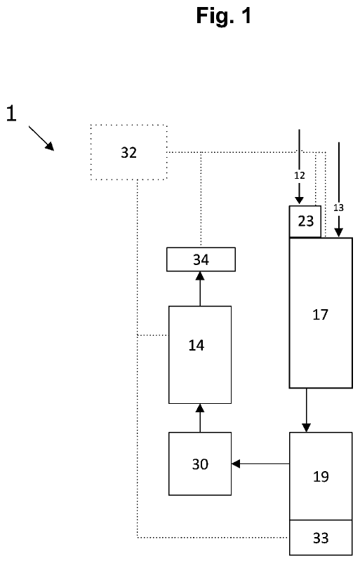

The claimed TOC analyzer in its entirety is provided with reference sign 11 and is illustrated in FIG. 1.

The TOC analyzer 11 serves to determine a carbon content of a sample. Depending upon the type and composition of the sample, it must still be prepared for the TOC analysis (however, the sample preparation per se is not an essential part of the present application). The sample 12 is introduced into a high-temperature furnace 17 by means of a reservoir vessel 23. The high-temperature furnace 17 is at its reaction temperature between 670 and 1,200° C., so that vaporization and/or oxidation of the sample 12 takes place. In some cases, the reaction runs by means of a catalyst. The water vapor formed is condensed in a condensation unit 19; in one embodiment this is coolable (cooling unit 33). The water vapor can be collected in a receptacle. An expansion chamber for preventing flow of condensed liquid back into the furnace 17 can be arranged between the furnace 17 and the receptacle.

The carbon dioxide gas produced during the vaporization and/or oxidation of the sample 12 is transported using a carrier gas to the analysis unit 14, in which the carbon content is determined. The carrier gas can be, for example, nitrogen, oxygen or a mixture of the two (“synthetic air”). If the carrier gas has at least traces of carbon dioxide gas, they must be removed from the carrier gas before it is introduced into the high-temperature furnace 17 (this is not part of the present inventive concept, but can still be part of the TOC analyzer). The carrier gas is introduced into the TOC analyzer via an inlet 13. This is represented by the arrow bearing reference sign 13 in FIG. 1. If, as mentioned above, the carrier gas is rendered CO2 free, the carrier gas is optionally introduced elsewhere. The carrier gas is typically introduced by means of a compressor or by means of compressed air. Frequently, regulatable pumps are also used, which are arranged in the TOC analyzer 11. The pumps are regulated such that the desired carrier gas flow is achieved, for example, via a mass flow measurement. The carrier gas is typically guided through the TOC analyzer from the inlet 13 to the analysis unit 14 by means of a suitable pressure. A filter, which is configured for filtering acid gases, dust and/or aerosols, is arranged in the flow path of the carrier gas upstream of the analysis unit 30. The path of the carrier gas is represented by dashed lines in FIG. 1.

A data processing unit 32 is also shown, which is designed to control the inflow and outflow of the sample from and into the reservoir vessel 23 (see below) or the high-temperature furnace 17, and to determine the carbon content of the sample 12. This is shown in FIG. 1 by dotted lines. The analysis unit 14 comprises, for example, a non-dispersive infrared sensor (NDIR sensor, i.e., an NDIR CO2 detector).

To determine the carbon content, in one embodiment the mass flow is measured by means of a mass flow measurement 34 of the carrier gas by the analysis unit 14. In this embodiment, the measured flow is finally multiplied by the carbon content of the sample, wherein this product is integrated over time, and the TOC concentration of the sample is determined from the integral.

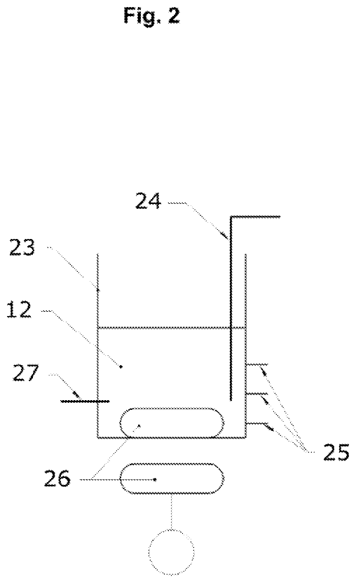

FIG. 2 shows the reservoir vessel 23 already mentioned above. The reservoir vessel 23 comprises a sample feed line 24 for the sample 12 and at least one sample removal line 25 which leads to the high-temperature furnace 17. The vessel comprises a stirrer 26 for stirring the sample 12 in the reservoir vessel 23. The vessel 23 further comprises at least one inlet 27 for introducing CO2-free medium, in particular air, into the sample 12, this then already being in the reservoir vessel 23.

The reservoir vessel 23 into which the sample 12 is conveyed thus serves as a “working vessel” for preconditioning the sample 23.

The stirrer 26 is, for example, a rotatable magnet on an axially aligned driven shaft (for example outside the vessel 23), for example driven by a motor (at the bottom in FIG. 2). In the vessel 23, the magnetic stirrer (the upper part of 26) is coated with a durable, non-abrasive inert material (e.g. Teflon).

The CO2-free air is introduced via the at least one inlet 27 (only one is shown; a plurality of inlets 27, i.e., in particular two, are possible), which is designed, for example, as a connected capillary (for example as a thin tube). The inlet 27 is attached as low as possible to the vessel 23 above the stirrer 26, which brings about greater dwell time and most effective mixing without disturbing the mixing process by stirrers. The immersion depth of the capillary into the vessel 23 is selected in such a way that distances from all walls are equal or, in the case of a plurality of capillaries, distances from the other capillaries are also equal. Furthermore, the inner diameter of the capillary is expediently selected with respect the process parameters (air flow rate). Ideally, many small air bubbles (large surface area) result in which coalescence does not occur during the ascent phase.

The sample feed line 24 is a supply line for the sample 12 to the reservoir vessel 23. At least one feed line 24 and a removal line 25 for suctioning off the pre-conditioned sample are necessary. The position of the sample removal line 25 is selected such that a representative sample can be taken from the vessel 23. In an ideally mixed vessel not comprising solids, the liquid is completely homogeneous. If undissolved particles are found in the sample 12, inhomogeneous distribution can occur within the vessel despite stirring. In order to counteract this, a plurality of lines 25 are attached at different heights (axial mixing assumed). Either a mixed sample, which is measured, can be generated therefrom, or the different samples are measured individually and then calculated mathematically to give an average concentration.

1. A TOC analyzer for determining a carbon content of a sample, comprising
a reservoir vessel having a sample feed line for the sample and at least one sample removal line to a high-temperature furnace, a stirrer for stirring the sample in the reservoir vessel and at least one inlet for introducing CO₂-free gas into the sample in the reservoir vessel;
the high-temperature furnace for vaporizing and/or oxidizing the introduced sample at a high temperature so as to form water vapor and carbon dioxide gas;
the analysis unit for determining the carbon content of the sample on the basis of the carbon dioxide gas produced from the vaporization and/or oxidation of the sample; and
a data processing unit which is designed at least to control the inflow and outflow of the sample from and into the reservoir vessel or the high-temperature furnace, and to determine the carbon content of the sample.

2. The TOC analyzer according to claim 1,
wherein the stirrer is configured as a magnetic stirrer.

3. The TOC analyzer according to claim 1,
wherein the reservoir vessel comprises at least two sample removal lines, wherein the sample removal lines are arranged at different heights.

4. The TOC analyzer according to claim 1,
wherein the inlet for introducing CO₂-free gas into the reservoir vessel is designed as a capillary.

5. The TOC analyzer according to claim 4,
wherein the reservoir vessel comprises at least two inlets for introducing CO₂-free gas.

6. The TOC analyzer according to claim 1,
wherein the inlet for introducing CO₂-free gas is arranged close to the bottom.

7. The TOC analyzer according to claim 1,
wherein the inlet for introducing CO₂-free gas protrudes into the reservoir vessel such that the distance from all walls and other inlets is equal.

8. The TOC analyzer according to claim 1,
wherein the reservoir vessel is designed as a hollow cylinder, in particular as a rotary part made of a plastics material.

9. The TOC analyzer according to claim 1,
wherein the TOC analyzer comprises an inlet for a carrier gas, wherein the inlet leads to a high-temperature furnace, wherein the carrier gas serves to transport the carbon dioxide gas formed in the high-temperature furnace during oxidation of the sample to the analysis unit.

10. The TOC analyzer according to claim 1, comprising
a filter between the high-temperature furnace and the analysis unit for filtering acid gases, dust and/or aerosols.
